(19) United States
(12) Patent Application Publication
(10) Pub. No.: US 2014/0238243 A1
(43) Pub. Date: Aug. 28, 2014

(54) APPARATUS FOR FILTERING AIR

(71) Applicants: Kip Jardine, Orem, UT (US); Jared Jardine, Orem, UT (US)

(72) Inventors: Kip Jardine, Orem, UT (US); Jared Jardine, Orem, UT (US)

(21) Appl. No.: 14/192,661

(22) Filed: Feb. 27, 2014

Related U.S. Application Data
(60) Provisional application No. 61/769,990, filed on Feb. 27, 2013.

(51) Int. Cl. B01D 46/00; B01D 46/42

(52) U.S. Cl. CPC B01D 46/0047; B01D 46/0036; B01D 46/4236
USPC 96/142; 55/467; 96/381

(57) ABSTRACT

An air filtering apparatus includes a housing defining a top opening and having a front portion defining a bottom opening. A filter is positioned within the top opening and sealed to the housing so that air flowing into the housing passes through the filter. An expansion chamber is in fluid communication with the bottom opening. A motorized fan is located within the housing and is configured for drawing air through the filter, into the housing and out through the expansion chamber. The air output of the motorized fan is directed toward a bottom of the housing proximate a rear of the housing with the expansion chamber extending from the air output of the motorized fan to the front portion of the housing.

### CROSS-REFERENCE TO RELATED APPLICATION

The present invention claims priority to U.S. Provisional Patent Application Ser. No. 61/769,990, filed on Feb. 27, 2013, entitled APPARATUS FOR FILTERING AIR, the entirety of which is incorporated herein by this reference.

### BACKGROUND OF THE INVENTION

1. Field of the Invention

The present invention relates generally to air filtering or purification systems and more specifically to an air filtering system that is capable of effectively filtering particles and airborne chemicals from the air within one or more rooms.

2. Description of Related Art

Improving air quality in a living environment is particularly important in cities where air pollution is a health concern. In addition, many suffer from allergies or asthma as a result of allergens or other contaminants in the air. Many air purification systems, designed and sold for home use, simply fail to adequately remove particles and contaminants from the air in an enclosed environment, such as a room, where the air purification system is located.

There are several different types of air cleaners and room deodorizers on the market today. These included ozone generators, electronic air cleaners, ionic air cleaners, ultra-violet light units, one room air cleaners, and scented candles and aerosols. Ozone Generators do not remove air pollution. They do, however, produce ozone that is used to deodorize the air. Electronic filtration products rapidly become less efficient. While they may meet comparable efficiencies when first installed their performance degrades quickly as the charged surface used to collect the pollutants becomes covered. In addition, these units do nothing to address air pollution problems caused by chemicals or gases. Ionic air cleaners are not capable of removing air pollution. Such devices are effectively one half of an electronic air cleaner, where particles are charged and collected on a surface. Units that use ultra-violet light rely on the sanitizing power of ultra-violet light to kill airborne bacteria and viruses, Studies show that while exposure to ultra-violet light does kill bacteria and viruses, a typical HVAC system application does not give the light enough time to kill the bacteria and viruses. Furthermore, these units do not remove any air pollution, There is a wide variety of small capacity air purifiers used as one-room air cleaners. These units are typically sized to handle approximately 80 square feet at most. In reality, such units provide little air filtering and any amount of air filtering is overcome by constant reintroduction of contaminated air that is common in most household environments. For example, when placed into a home with a forced air HVAC system, the circulation of the air in the home easily overwhelms the capacity of the unit. Also, these small units do nothing to address air pollution problems caused by chemicals or gasses. Scented candles and other room deodorizers are designed to treat the symptom of odors in the home without addressing its cause, They do not remove any air pollution; instead they mask the odor with a pleasant smelling chemical.

A typical breath of air is approximately 500 cc for an average person. Considering that air having high particulate content can have 1,000,000 particles or more in each 500 cc of air, a person, with a breath rate of 16 breaths per minute, will breath in 16,000,000 particles or more every minute. Air having particles of 0.01 microns or larger in concentrations of 2,000 particles per cc or greater is considered poor. Such particle sizes are, however, relatively difficult to filter from the air without large commercial air purification systems. Moreover, prior art home air filtering appliances are simply not capable of maintaining a room with desired low levels of such particles. Thus, there exists a need in the art to provide an effective device for removing particles, such as particles that are typically found in polluted air that can be placed in an enclosed or semi-enclosed environment, such as a house that includes a plurality of adjoining rooms and that has a significant and measurable impact on air quality within the enclosed or semi-enclosed environment.

Prior art home air filtration systems are typically small table top or floor units that use a small fan and a filter in which air in the room is drawn by the fan into the unit and forced through a filter, which may be a HEPA filter or the like. In reality, such small home air filtration systems do little if anything to reduce small particulates in the air that can be a source of health problems for people, such as allergies and other breathing disorders. That is, they are not capable to circulating enough air through the system to make a significant difference in the air quality in a room or structure. In addition, such systems are typically not made to be operated continuously. Without continuous or near-continuous operation, a room with relatively clear air will quickly become recontaminated with particles when the air filtering system is turned off. As such, there exists a need in the art to provide an air filtering system that uses multiple filters to filter out the smallest of particles, that is configured to operate continuously, is capable of moving significant amounts of air in order to significantly reduce air particulates to near zero measurability and does so in a manner that is relatively quiet.

### SUMMARY OF THE INVENTION

Accordingly, the present invention provides an apparatus for filtering particles from air in an environment in a significant and measurable amount that has a material impact on the air quality of the environment. The air filtering device of the present invention includes an exterior housing having an air return or input opening located at the top of the device and a vent or output opening located at the bottom of the device. A motor and fan are located within the housing. A filtering system is interposed between the input opening and the fan so that any air drawn into the device is filtered so as to remove over 99% of measurable particulates in the air.

In one embodiment, the apparatus draws air in from the top of the device at an angle toward the back of the device and exhausts the purified air directly forward. This facilitates rapid mixing of the purified air throughout the room, and avoids “zoning”, which is effectively zones of purified air adjacent zones of unpurified air that are not effectively being circulated through the unit.

In order to ensure that air flowing out of the unit has been passed though the filtration system, the device utilizes gravity, precision fit, and Z-Channel brackets to fully seal the filtration system to the interior of the housing.

The device employs a HEPA filter that substantially fills the top or input opening of the device.

The fan directs air from within the housing that has necessarily passed through the filtration system proximate the rear of the device. The air then flows through a duct comprising a first curved portion, which acts as a flow diverter, adjacent the exit of the fan toward the front of the device and, before exiting the device, passes through an expansion chamber proximate the front of the device at the output. The flow diverter reduces restriction of the flow of air into the expansion chamber. Passing the air through the expansion chamber prior to being expelled from the device decreases the velocity of the air exiting the device and significantly reduces air noise that would otherwise be present. In addition, by facing the exit of the fan downward and proximate the rear of the device, mechanical noise from the fan and motor is significantly decreased. In addition, safety is increased because the blades of the fan are not visible

The device uses a half hp ECM motor. ECM motors are very efficient, but have not generally been usable in residential applications because of high levels of electromagnetic interference. The device of the present invention solves the electromagnetic interference problem by using a powerful line filter to eliminate the wiring feedback.

The device also employs flush mounted PEM fasteners throughout. This allows precision without having to use plastic parts and/or adhesives, which tend to emit harmful chemicals.

These and other features of the present invention are more fully described in the detailed description of the invention with reference to the drawings.

### BRIEF DESCRIPTION OF THE DRAWINGS

When considered in connection with the following illustrative figures, referring to the detailed description may derive a more complete understanding of the present invention. In the figures, like reference numbers refer to like elements or acts throughout the figures.

FIG. 1 is a front perspective view of an air filtering system according to the principles of the present invention.

FIG. 2 is a back perspective view of the air filtering system illustrated in FIG. 1.

FIG. 3 is a partial right side cross-sectional view of the air filtering system illustrated in FIG. 1.

FIG. 4 is a top front side cross-sectional view of the air filtering system illustrated in FIG. 1.

FIG. 5 is a top partial cross-sectional view of the air filtering system illustrated in FIG. 1. (with wiring omitted for the sake of clarity)

FIG. 6 is a graph of fan speed and noise versus living space.

FIG. 7 is a front perspective view of the air filtering system with a noise reducing cover according to the principles of the present invention.

FIG. 8 is a front perspective view of the air filtering system with the noise reducing cover separated therefrom according to the principles of the present invention.

Elements and acts in the figures are illustrated for simplicity and have not necessarily been rendered according to any particular sequence or embodiment.

### DETAILED DESCRIPTION OF THE INVENTION

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. It is noted that the inventor can be his own lexicographer. The inventor expressly elects, as his own lexicographer, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventor's intent and desire that the simple, plain and ordinary meaning to the terms be applied to the interpretation of the specification and claims.

The inventor is also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventor is fully informed of the standards and application of the special provisions of 35 U.S.C. §112, ¶6. Thus, the use of the words “function,” “means” or “step” in the Detailed Description of the Invention or claims is not intended to somehow indicate a desire to invoke the special provisions of 35 U.S.C. §112, ¶6, to define the invention. To the contrary, if the provisions of 35 U.S.C. §112, ¶6 are sought to be invoked to define the inventions, the claims will specifically and expressly state the exact phrases “means for” or “step for” and the specific function (e.g., “means for filtering”), without also reciting in such phrases any structure, material or act in support of the function. Thus, even when the claims recite a “means for . . . ” or “step for . . . ” if the claims also recite any structure, material or acts in support of that means or step, or that perform the recited function, then it is the clear intention of the inventor not to invoke the provisions of 35 U.S.C. §112, ¶6. Moreover, even if the provisions of 35 U.S.C. §112, ¶6 are invoked to define the claimed inventions, it is intended that the inventions not be limited only to the specific structure, material or acts that are described in the illustrated embodiments, but in addition, include any and all structures, materials or acts that perform the claimed function as described in alternative embodiments or forms of the invention, or that are well known present or later-developed, equivalent structures, material or acts for performing the claimed function.

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention. It should be noted that there are many different and alternative configurations, devices and technologies to which the disclosed inventions may be applied. Thus, the full scope of the inventions is not limited to the examples that are described below.

Various aspects of the present invention may be described in terms of functional block components and various processing steps. Such functional blocks may be realized by any number of hardware or software components configured to perform the specified functions and achieve the various results. Various representative implementations of the present invention may be applied to any system for purifying air.

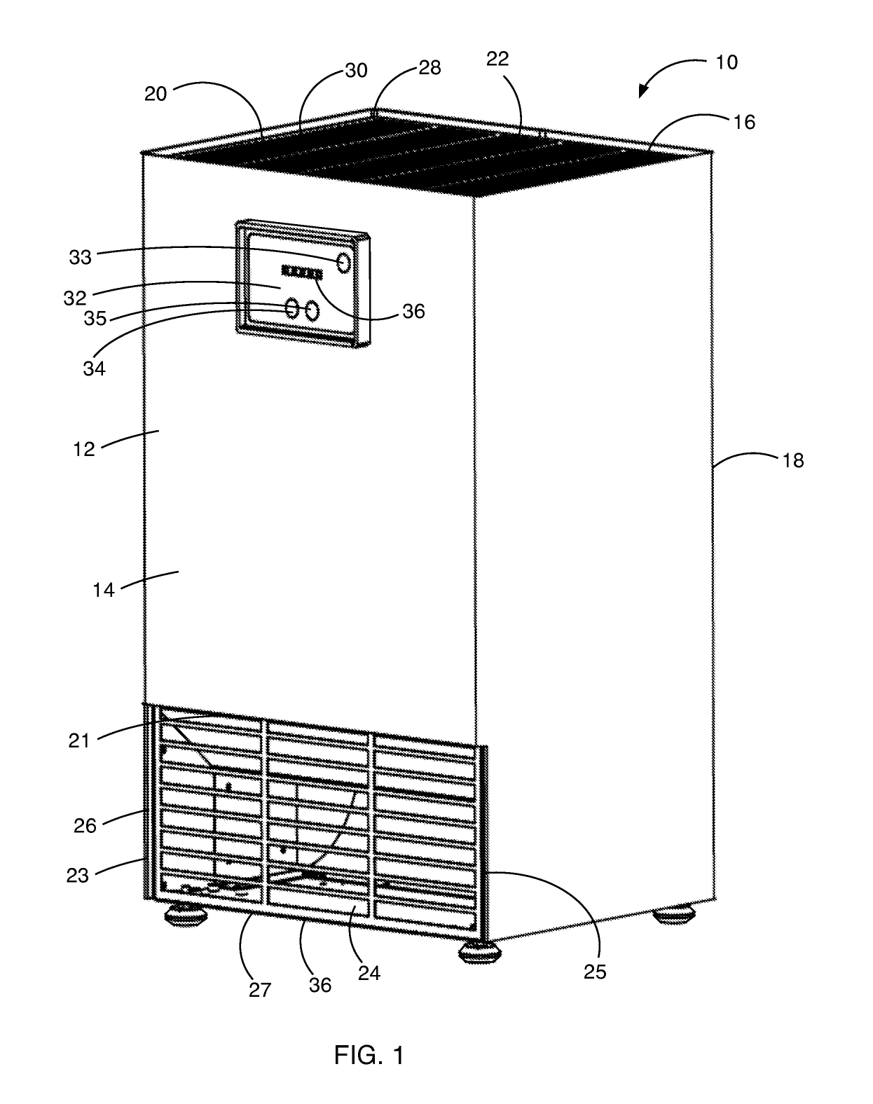

Referring now to FIG. 1, an air filtering and purification system, generally indicated at 10, is illustrated. The air filtering system 10 comprises a housing 12 having a front side wall 14, a back side wall 16, a right side wall 18 and a left side wall 20. Each of the front, back, right and left side walls are substantially surrounded by a cover 100, as will be described in more detail herein. The front, back, left and right side walls 14, 16, 18 and 20, respectively, define a top opening 22. The front side wall 14 defines a bottom opening 24 in a bottom portion 26 of the front wall 14 between a bottom edge 21 of the front wall 14, side edges 23 and 25 of the right side wall 18 and left side wall 20, respectively, and a front edge 27 of a bottom panel 36. The top opening 22 is provided with a louvered panel 28 with angled louvers. The top opening 22 substantially fills the space defined by the top edges of the front, back, left and right side walls 14, 16, 18 and 20. A filter 30 is positioned under the panel 28 and within the housing 12 in fluid communication with the top opening 22. The edges of the filter 30 are sealed to the inside of the housing so that substantially all air entering the housing 12 will pass through the filter 30. The front, back, left and right side walls 14, 16, 18 and 20 are also engaged with one another so that virtually or substantially all of the air entering the top opening 22 that passes through the filter 30 exits through the bottom opening 24. A control panel 32 is located on the front wall 14 proximate a top portion of the housing 12. The control panel 32 includes an on/off button 33, and two control buttons 34 and 35. The control buttons 34 and 35 control the fan motor speed. Light indicator 36 includes 5 lights, with each light lit in succession depending on the fan motor speed selected by a user, with one light being lit for the lowest fan speed and all five lights being lit for the highest fan speed.

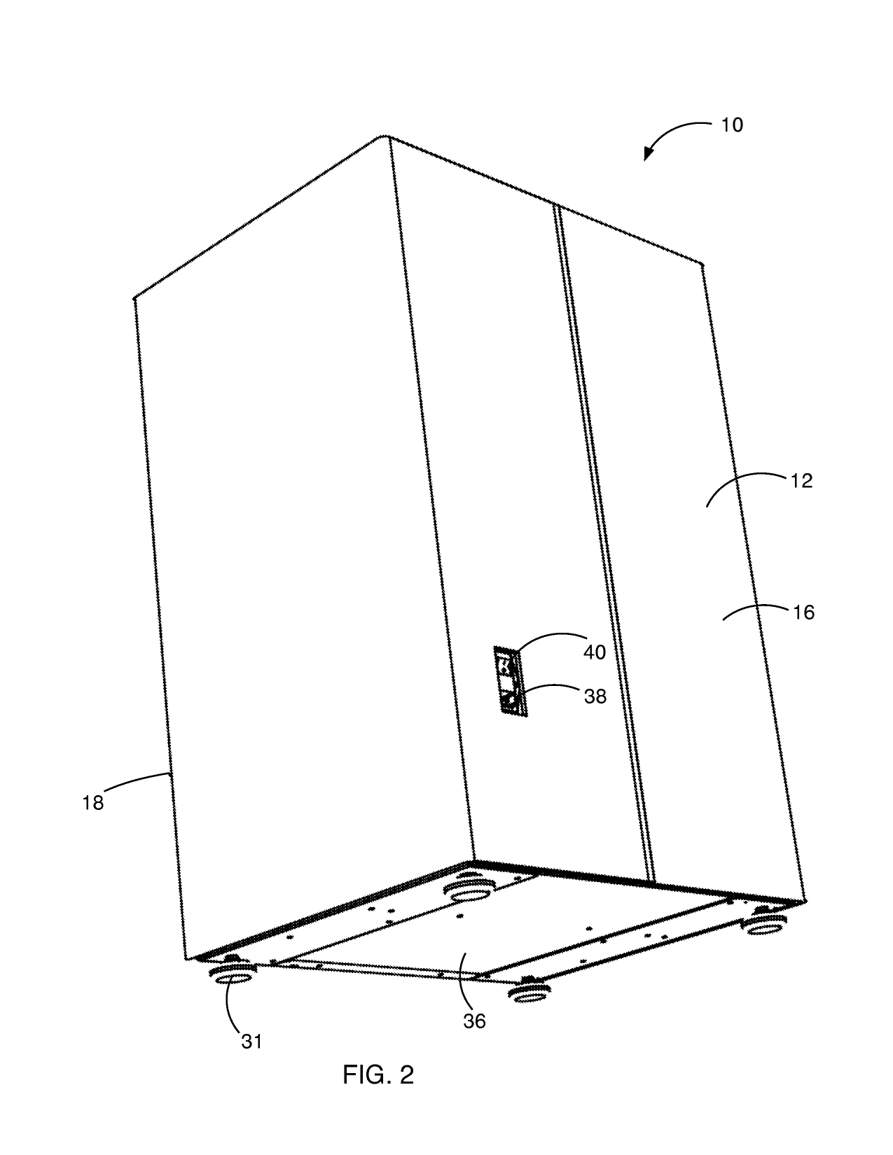

Referring now to FIG. 2, the side walls, including side walls 16 and 18, as well as the bottom panel 36 are sealed or engaged relative to one another so that air flowing into the housing 12 must flow through the fan and out through the bottom opening 24. A power cord adapter 38 is provided in the back wall 16 of the housing 12 for power connection as well as an on/of switch 40 so as to prevent operation of the machine from the front panel 32. Leveling feet, such as leveling foot 31, are shown in the bottom of the housing 12, but wheels or other devices known in the art may be used.

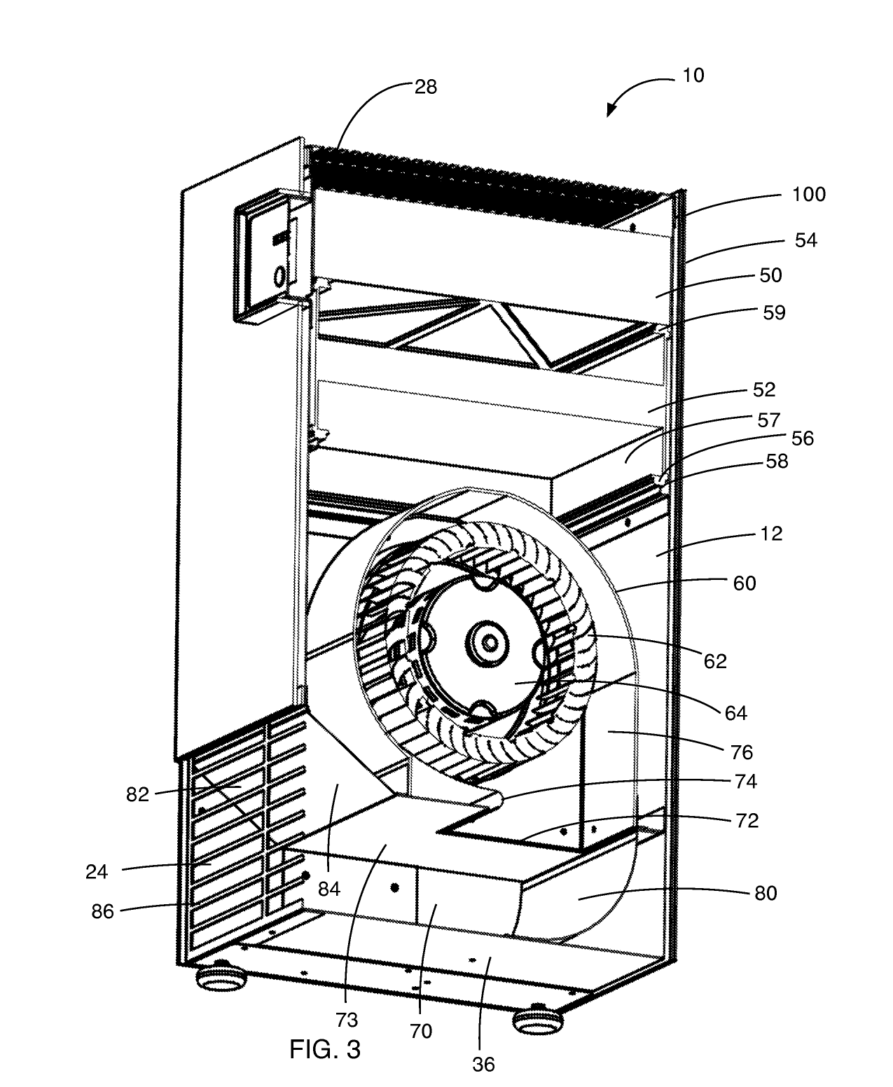

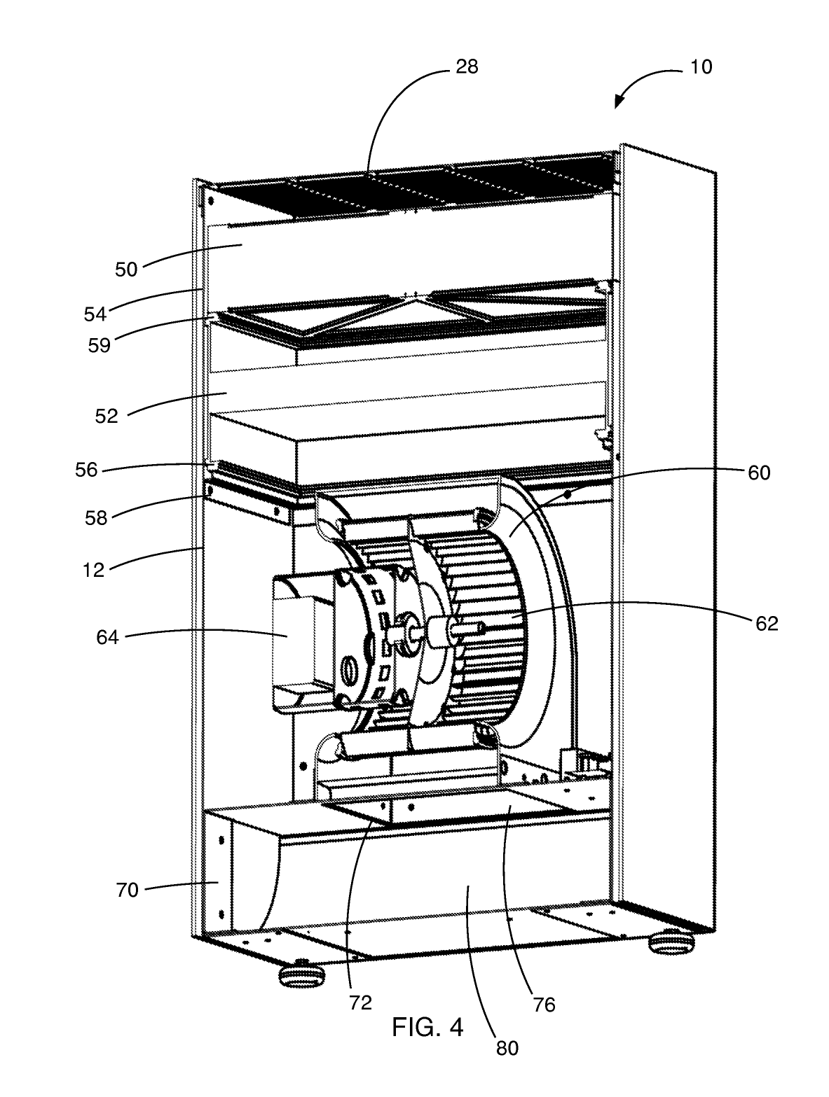

As illustrated in FIGS. 3 and 4, a pair of filters 50 and 52 is mounted within the upper portion 54. Air entering the louvered panel 28 must pass through the two filters. The filters may be HEPA filters that are capable of removing substantially all measurable particles from air passing through the filters. Although it is common for HEPA filter manufacturers to state, “removes particles down to 0.3 microns,” this is often in error. Particles of 0.3 micron in diameter are some of the most difficult particles to capture. The air filtering system 10 of the present invention is capable of removing particles down to 0.01 microns. As such, the air is not only purified but also deodorized. The air filtering system 10 of the present invention is able to capture smaller particles at a higher rate than the 99.97% required to make a HEPA claim. The first filter 50 may be a Pleated Mery 8 Prefilter mated to a 2″ activated carbon pad or other similar filter known in the art. The activated carbon pad removes chemical vapors and gases to further eliminate odors that may be present in the air. The air purification system of the present invention is capable of removing virtually all solid particles in the air and capturing over 300 of the most common gases, odors and chemical vapors. The second filter 52 may be a true HEPA filter or other similar filter known in the art. The upper filter 50 may rest upon the second filter 52 or be spaced therefrom. Thus, the first or upper filter 50 may be held against the second or lower filter 52 by gravity or supported above the second filter with internal support members as described herein. The second filter 52 is held in place by a plurality of Z-shaped brackets 58 that extend around the perimeter of the filter 52 and are mounted to the inside surface of the housing 12. As shown, the lower flanges of the Z-shaped brackets 58 are mounted as with a plurality of fasteners to the inside surface of the housing 12. Each Z-shaped bracket 58 has an upper L-shaped portion that defines a space between the housing 12 and an upper flange portion of the Z-shaped bracket. The upper flange portion has an upper edge that is parallel to and spaced from the inside surface of the housing 12 to form a lip upon which the seal 56 of the filter 52 rests. The distance of the lip or upper edge of the Z-shaped bracket 58 and the inside surface of the housing 12 is approximately the same distance as a distance between the inside surface of the housing 12 and a longitudinal centerline of the seal 56. As such, the upper edge of the Z-shaped bracket thus forms the seal between the housing 12 and the filter 52. The Z-shaped bracket prevents air from flowing around the outside of the filter 52 between the filter 52 and the interior walls of the housing. The filter 52 is thus effectively held up or supported by Z-shaped brackets 58 that abut against a rubber seal 56 that extends around the lower perimeter of the second filter 52 so that air cannot pass between the filter 52 and the housing 12. In one embodiment, the lower perimeter edge of the upper filter 50 rests upon an upper perimeter seal 59 of the second filter 52 so as to form a seal between the upper filter 50 and the lower filter 52 in a similar manner as the lower seal 56 rests upon the Z-shaped bracket 58. This ensures that the air flowing through the upper filter 50 must pass through the lower filter 52 and cannot flow around the filter 52.

Positioned below the filter 52 within the housing 12 is a fan housing 60. The fan housing 60 partially circumscribes a rotary fan 62 that is motor driven with motor 64. The fan 62 draws air from within the space 57 between the filter 52 and the motor housing 60 and directs the air downwardly into an expansion chamber 70. The fan housing 60 is generally cylindrical for approximately 270 degrees and defines a lower vent opening 72 in communication with the expansion chamber 70. A radial transition surface 74 is formed between a front edge of the vent opening 72 and the top surface 73 of the expansion chamber 70. The lower rear portion 76 of the fan housing 60 is vertically oriented and joins the cylindrical portion of the fan housing 60 with the back wall 80 of the expansion chamber 70. The back wall 80 of the expansion chamber 70 is radially curved between the lower rear portion 76 and the bottom panel 36 of the housing 12. This provides a smooth and directed flow of air from the fan 62 into the expansion chamber in a manner that minimizes noise from the air flow.

To further decrease noise from the air flow, the front portion 82 of the expansion chamber 70 has an upwardly angled top wall 84. As air flows through the expansion chamber 70, the air enters the expansion portion of the expansion chamber 70 and effectively slows. This causes a decrease in noise from the air exiting the housing, especially as it passes through the grill 86 of the opening 24. The angled top wall 84 is angled relative to horizontal at an angle of approximately 45 degrees but may also be effective at an angle of between about 30 degrees to about 60 degrees. Also, because the vent opening 72 of the fan housing 60 is proximate the rear of the housing 12 and because the air exiting the fan 60 is first directed downwardly toward the bottom panel 36, noise from the motor and fan are further minimized. As further described herein, vibrational noise is also minimized with the insulated cover 100 that extends around the perimeter sides of the housing 12.

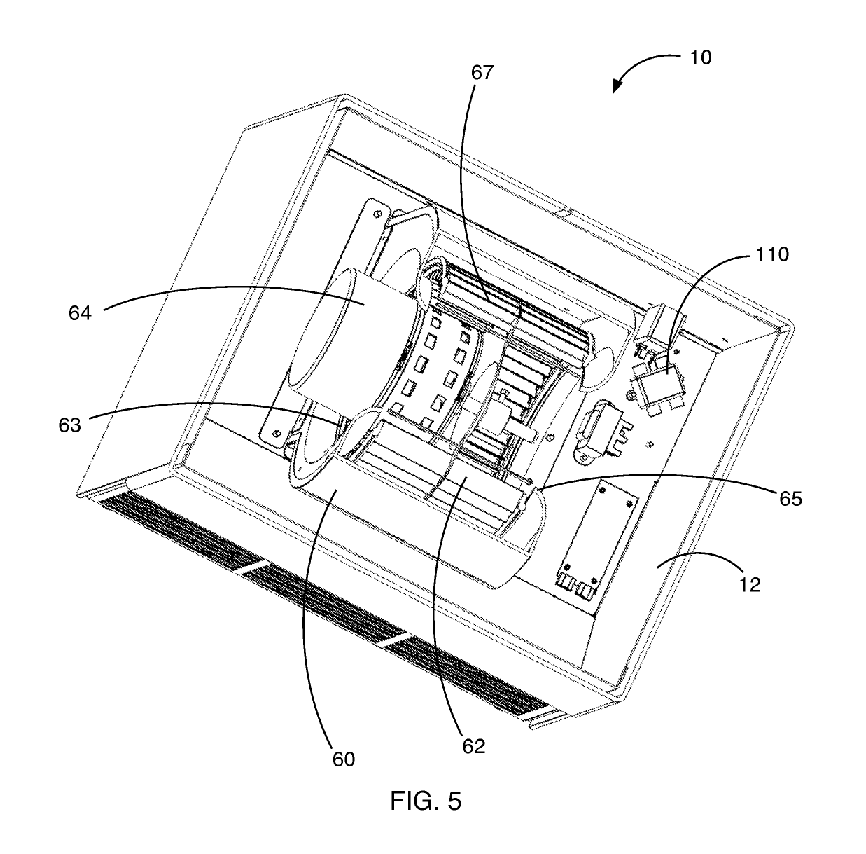

FIG. 5 further illustrates the position and configuration of the fan housing 60 within the housing 12. The cylindrical portion of the fan housing 60 wraps around the outer perimeter of the fan 62 and includes circular and inwardly curved air inlets 63 and 65. On one side, the air flows in through the inlet 63 around the motor 64, into the fan housing 60 and subsequently into the expansion chamber. On the other side proximate the shaft side of the motor 64, the air flows through the inlet 65, into the fan housing 60 and subsequently into the expansion chamber. Thus, the blades 67 of the fan 62 are angled to pull or draw filtered and purified air from the motor chamber or space 57 into the expansion chamber 70 below the fan housing 60.

The filtering device 10 employs the use of a 1/2 hp ECM motor. Such ECM motors are relatively highly efficient, but have not generally been used or recognized as usable in in room residential applications because of the relatively high levels of electromagnetic interference they produce. The filtering device 10 of the present invention solves the electromagnetic interference problem by using a powerful line filter 110 to eliminate wiring feedback.

The device 10 of the present invention also employs flush mounted PEM fasteners throughout to attach the various components together, such as the housing components. This allows precision without having to use plastic parts and/or adhesives, which tend to emit harmful chemicals, of which the device 10 is designed to eliminate from the air.

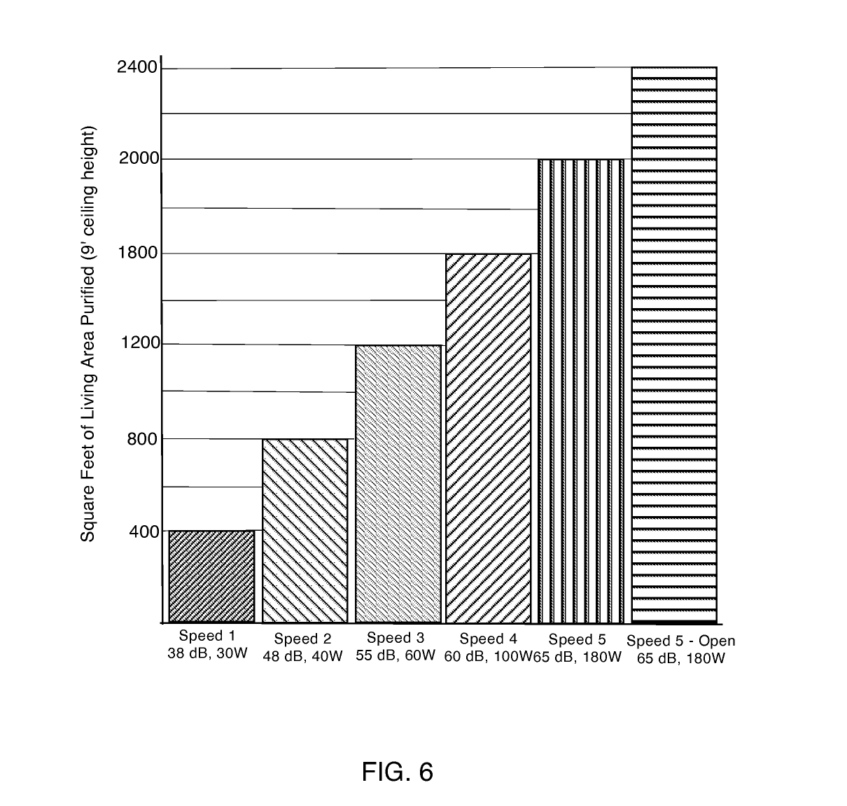

As shown in FIG. 6, a graph of the fan speeds between 1 and 5 in relation to the square feet of living area purified for a ceiling of nine feet is shown. In addition, the graph provides the noise level in dB and power used at each fan speed setting. At the lowest setting, Speed 1, the device is capable of effectively purifying the air of a 400 square feet home or enclosed space. A “home” as set forth herein refer to an enclosed structure comprising one or more adjoining rooms. In a home environment, where multiple adjoining rooms exist, the flow of air and thus circulation of that air are restricted by the various walls. At Speed 1, the device generates 39 dB of noise and uses 33 Watts of power. At Speed 2, the device is capable of effectively purifying the air of an 800 square feet multi-room home and generates 48 dB of noise and uses 51 Watts of power. At Speed 3, the device is capable of effectively purifying the air of a 1,200 square feet multi-room home and generates 54 dB of noise and uses 100 Watts of power. At Speed 4, the device is capable of effectively purifying the air of a 1,600 square feet multi-room home and generates 59 dB of noise and uses 158 Watts of power. At Speed 5, the device is capable of effectively purifying the air of a 2,000 square feet multi-room home and generates 63 dB of noise and uses 273 Watts of power. At maximum speed, and in a single enclosed area (i.e., a single large room where circulation of air is not interrupted by walls) the device is capable of effectively purifying the air of a 2,400 square feet space and generates 63 dB of noise and uses 273 Watts of power. Thus, for each of the speeds 1-4, the air purifying capabilities of the device in a single enclosed room will increase approximately 20% or more. Moreover, the device is relatively efficient, only consuming about the same amount of electricity as a single 100 Watt incandescent light bulb when operated at Speed 3.

It is important to minimize noise of the air filtering apparatus 10 of the present invention. It has been found that in home devices that produce excessive sound (e.g., greater than 55 dB of noise) for any extended period of time will not be used by the consumer. The air filtering apparatus 10 of the present invention is configured to be run continuously so that the air is constantly being purified. This is necessary to maintain low levels of particulates in the air that will quickly reenter the space if the device is turned off for any extended period of time. As such, the present invention needs to be relatively quite for users to be willing to take full advantage of its capabilities. In areas where the device according to the present invention have been tested, air having particulate concentrations as high as 20,000 to 50,000 particles per cc have been reduced to less than 2000 particles per cc and in some cases as low as 1000 particles per cc when measured with a portable particle counter, such as the TSI 3007. Such low particulate levels are maintained consistently regardless of outside conditions so long as the air filtration system of the present invention is in continuous operation.

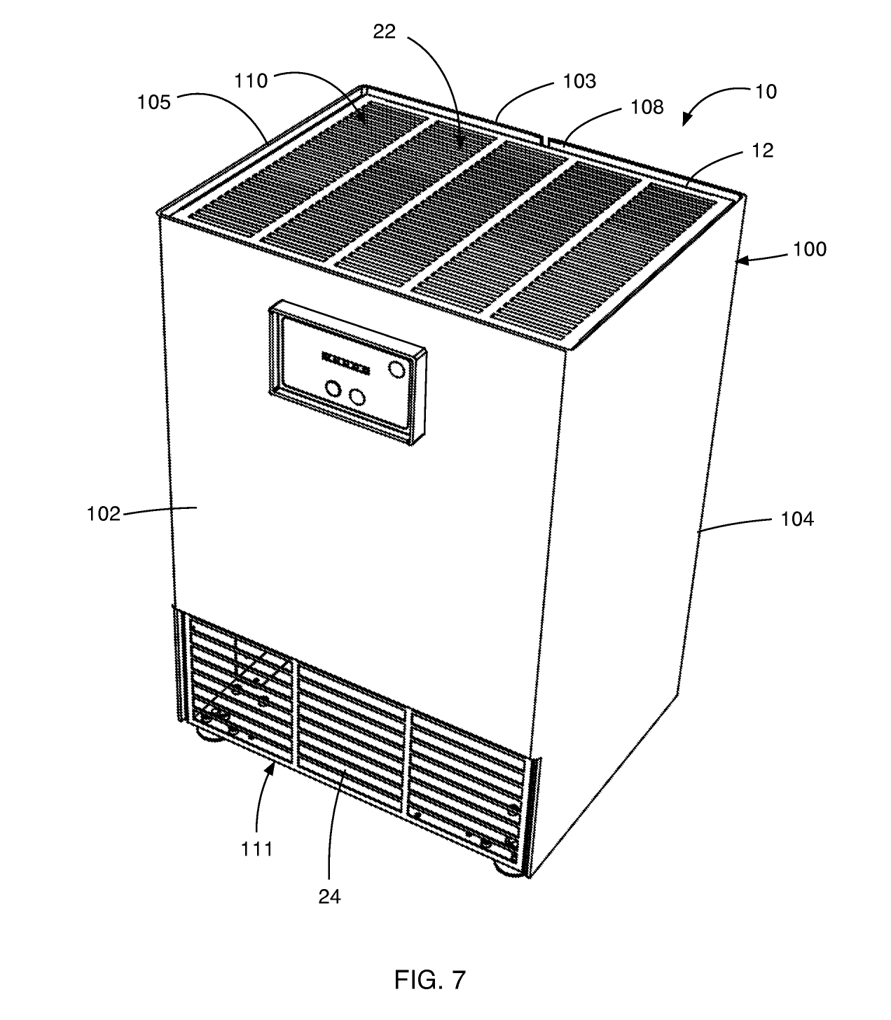

As shown in FIG. 7, in order to further reduce noise of the air filtration device 10, a housing cover 100 is disposed around the housing 12. The housing cover 100 includes front, back, right side and left side panel sections, 102-105, respectively. The housing cover 100 is formed from an insulated fabric having a padded layer that is in contact with relative outside surfaces of the side walls of housing 12, specifically the front, back, left and right side walls 14, 16, 18 and 20 of the apparatus 10. The top of the cover 100 is open so as to not restrict any flow of air into the housing 12 through the panel 28. That is, the top edge 108 of the cover 100 defines a top opening 110 to surround the upper opening 22 in the housing and substantially match the size and shape of the upper opening 22 in the housing 12 so as to not restrict any flow into the upper opening 22. Likewise, the front 102 of the cover 100 has an opening 111 around the opening 24 in the front side of the housing 12 so as to surround the opening 24 on at least the top and sides thereof, but in a manner that will not restrict any flow of air exiting the housing 12. In addition, a small opening is provided for exposing the control panel as well as a small opening for the power cord and on/off switch in the back (not shown). The cover 100 significantly reduces mechanical noise of the apparatus 10 due to vibration of the front, back, left and right side walls 14, 16, 18 and 20 of the housing 12 than can either rattle or reverberate vibrations and/or noise emanating from the motor and/or fan. As such, with the cover 100 installed as shown in FIG. 6, even at the highest fan setting little if any mechanical noise can be heard with the only sound emanating from the unit being that of the flow of air being forced out of the lower opening in the front of the housing 12. Indeed the apparatus 10, despite its relatively large size and use of commercial grade motors and fans, is more quite than many portable fans or air conditioning units even though it is capable of moving significantly more air than such portable fans or air conditioning units.

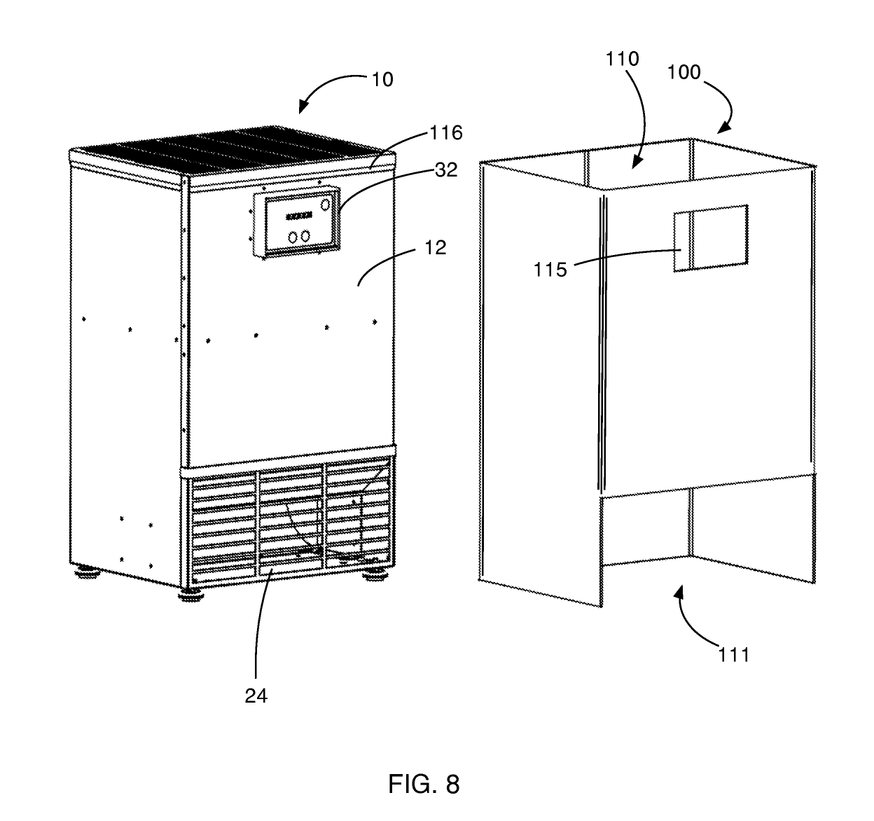

FIG. 8 shows the air filtration and purification device 10 according to the present invention separated from the cover 100. As shown, the cover 100 is sized and shaped to fit around the housing 12 in a relatively snug configuration and includes the top opening 110 for fitting around the top of the device 10 and a bottom opening for fitting around the bottom of the device with the opening 111 sized and shaped to fit around the bottom opening 24 of the device 10. The cover 100 may include other openings, such as opening 115 sized and shaped to fit around control panel 32. The cover 100 may be attached to the housing 12 with a plurality of sections of hook and loop tape 116 that are positioned around a top portion of the housing 12. One portion of the hook and loop tape is attached to the side walls of the housing 12 with the other corresponding portion of the hook and loop tape attached to a top portion of the cover 100, so that at least the top portion of the cover 100 is temporarily attached to the top portion of the housing 12. This prevents the cover from sagging or sliding down relative to the housing 12. The back seam 118 of the cover 100 is selectively openable and may be secured together with a zipper, hook and loop tape, snaps or other fasteners known in the art. Likewise, the hook and loop tape 116 may be replaced with a series of snaps or other temporary fasteners known in the art.

The overall size of the device 10 is relatively compact considering the size of the motor, fan and filters capable of moving sufficient air in order to sufficiently filter air in a room or other enclosed space according to the data shown in FIG. 6. While size is not necessarily critical to the operation of the device, an air filtration system according to the present invention may have outer dimensions of approximately 33 inches tall, 17 inches deep and 22 inches wide. The depth and width of the device may be somewhat dependent upon typical sizes of commercially available filters, such as True HEPA filters. That is, in order to accommodate commercially available filters, the housing is just large enough to receive and support, as previously describe, the filters that are inserted therein. The motor and fan are also sized to create a sufficient movement of air through the filters to maintain a constant flow of air through the filters while the device is in operation.

In the foregoing specification, the present invention has been described with reference to specific exemplary embodiments. Various modifications and changes may be made, however, without departing from the spirit and scope of the present invention as set forth in the claims. The specification and figures are illustrative, not restrictive, and modifications are intended to be included within the scope of the present invention. Accordingly, the scope of the present invention should be determined by the claims and their legal equivalents rather than by merely the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Benefits, other advantages, and solutions to problems have been described above with regard to particular embodiments. Any benefit, advantage, solution to problem, or any element that may cause any particular benefit, advantage, or solution to occur or to become more pronounced are not to be construed as critical, required, or essential features or components of any or all the claims.

The terms “comprise”, “comprises”, “comprising”, “having”, “including”, “includes” or any variations of such terms, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials, or components used in the practice of the present invention, in addition to those not specifically recited, may be varied or otherwise particularly adapted to specific environments, manufacturing specifications, design parameters, or other operating requirements without departing from the general principles of the same.

What is claimed is:

1. An air filtering apparatus, comprising:
a housing having a front side wall, a back side wall, a right side wall and a left side wall, the front, back, left and right side walls defining a top opening and the front side wall defining a bottom opening in a bottom portion thereof;
at least one filter positioned within the housing and in fluid communication with the top opening and sealed along its edges to the housing;
an expansion chamber in fluid communication with the bottom opening, the expansion chamber having a first portion having a first cross-sectional size and a second portion that expands from the first cross-sectional size to a second larger cross-section size proximate the bottom opening; and
a motorized fan located within the housing between the at least one filter and the bottom opening configured for drawing air through the filter, into the housing and out through the expansion chamber.

2. The air filtering apparatus of claim 1, wherein the at least one filter comprises a first filter and a second filter, the first filter positioned adjacent to the second filter and further comprising a seal interposed between the first filter and the second filter to cause air flowing through the first filter to also flow through the second filter.

3. The air filtering apparatus of claim 2, wherein the first filter comprises a filter and a carbon pad and the second filter comprises a HEPA filter.

4. The air filtering apparatus of claim 1, wherein the housing defines a space between the at least one filter and a bottom panel and wherein the motorized fan is positioned within the space, wherein the bottom panel defines lower vent opening positioned proximate the back side wall of the housing and in fluid communication with the expansion chamber.

5. The air filtering apparatus of claim 1, wherein the motorized fan comprises a fan housing having a generally cylindrical portion extending approximately 270 degrees and defines a lower vent opening in fluid communication with the expansion chamber.

6. The air filtering apparatus of claim 5, further comprising a radial transition surface between a front edge of the lower vent opening and a top surface of the expansion chamber.

7. The air filtering apparatus of claim 6, wherein a lower rear portion of the fan housing is vertically oriented and joins the cylindrical portion of the fan housing with a back wall of the expansion chamber to direct air from the fan housing in a downward direction.

8. The air filtering apparatus of claim 7, wherein the back wall of the expansion chamber is radially curved between a lower rear portion and a bottom panel of the housing.

9. The air filtering apparatus of claim 8, wherein a front portion of the expansion chamber has an upwardly angled top wall to slow the flow of air exiting the housing through the bottom opening.

10. The air filtering apparatus of claim 9, wherein the angled top wall is angled relative to horizontal at an angle of approximately between about 30 degrees and 60 degrees. 45 degrees but may also be effective at an angle of between about 30 degrees to about 60 degrees.

11. The air filtering apparatus of claim 1, further comprising a noise reducing cover comprised of an insulated material secured around the front side wall, back side wall, right side wall and left side wall of the housing, the cover defining an upper opening surrounding the top opening of the housing and a lower opening surrounding on at least three sides the bottom opening of the housing.

12. An air filtering apparatus, comprising:
a housing defining a top opening and having a front portion defining a bottom opening in a bottom portion thereof;
a filter positioned within the top opening and sealed to the housing so that air flowing into the housing passes through the filter;
an expansion chamber in fluid communication with the bottom opening, the expansion chamber extending from a back portion of the housing to the bottom opening and having a first portion defining a first cross-sectional space and a second portion that expands from the first cross-sectional space to a second larger cross-section space that terminates proximate the bottom opening; and
a motorized fan located within the housing and configured for drawing air through the filter, into the housing and out through the expansion chamber, the air output of the motorized fan being directed toward a bottom of the housing proximate a rear of the housing with the expansion chamber extending from the air output of the motorized fan to the front portion of the housing.

13. The air filtering apparatus of claim 12, wherein the at least one filter comprises a first filter and a second filter, the first filter positioned adjacent to the second filter and further comprising a seal interposed between the first filter and the second filter to cause air flowing through the first filter to also flow through the second filter, the first filter comprising a combination filter and a carbon pad and the second filter comprising a HEPA filter.

14. The air filtering apparatus of claim 12, wherein the motorized fan comprises a fan housing having a generally cylindrical portion extending approximately 270 degrees and defines a lower vent opening in fluid communication with the expansion chamber.

15. The air filtering apparatus of claim 14, further comprising a radial transition surface between a front edge of the lower vent opening and a top surface of the expansion chamber.

16. The air filtering apparatus of claim 15, wherein a lower rear portion of the fan housing is vertically oriented and joins the cylindrical portion of the fan housing with a back wall of the expansion chamber to direct air from the fan housing in a downward direction.

17. The air filtering apparatus of claim 16, wherein the back wall of the expansion chamber is radially curved between a lower rear portion and a bottom panel of the housing.

18. The air filtering apparatus of claim 17, wherein a front portion of the expansion chamber has an upwardly angled top wall to slow the flow of air exiting the housing through the bottom opening.

19. The air filtering apparatus of claim 18, wherein the angled top wall is angled relative to horizontal at an angle of approximately between about 30 degrees and 60 degrees. 45 degrees but may also be effective at an angle of between about 30 degrees to about 60 degrees.

20. The air filtering apparatus of claim 12, further comprising a noise reducing cover comprised of an insulated material secured around the front side wall, back side wall, right side wall and left side wall of the housing, the cover defining an upper opening surrounding the top opening of the housing and a lower opening surrounding on at least three sides the bottom opening of the housing.
